(19) United States
(12) Patent Application Publication
(10) Pub. No.: US 2022/0235870 A1
(43) Pub. Date: Jul. 28, 2022

(54) Six Port Valve

(71) Applicant: Dan Knapper, Itasca, IL (US)

(72) Inventor: Dan Knapper, Itasca, IL (US)

(21) Appl. No.: 17/542,978

(22) Filed: Dec. 6, 2021

Related U.S. Application Data
(60) Provisional application No. 63/141,537, filed on Jan. 26, 2021.

(51) Int. Cl. F16K 11/085; F16K 27/06

(52) U.S. Cl. CPC F16K 11/0853; F16K 27/065

(57) ABSTRACT

A multi-valve port has a housing with first and second inlet ports which selectively feed first, second, third and fourth outlet ports. Flow from the inlet ports is fluidly separated from each other through the valve. The housing has a cavil which receives a stemshell which rotates to provide a plurality of positions. A first position has the first inlet port providing fluid flow to the first outlet port and the second inlet port providing fluid flow to the third outlet port. A second position has fluid from the first inlet port to both the first and second outlet ports. Some outlet ports may be blocked off, secured, or otherwise receive no flow from either of the inlet ports in certain positions. Some pairs of outlet ports may receive flow from a single inlet port in certain positions.

### CLAIM OF PRIORITY

This patent application claims the benefit of U.S. Provisional Application No. 63/141,537 filed Jan. 26, 2021, which is incorporated herein by reference in its entirety.

### FIELD OF THE INVENTION

The present invention relates to a multiport valve such as a six port valve having multiple positions such as six distinct positions (flow configurations) amongst the various ports such as two inlet and four outlet ports.

### BACKGROUND OF THE INVENTION

The applicant was requested by a customer to provide a fluid control valve which could operate in one of six different flow configurations amongst two inlet ports and four outlet ports. Specifically, the inlet ports are numbered 1 and 2, the outlet ports are numbered 3-6. The customer manufactures electric vehicles and such fluid control valves may be used with a thermal system thereof.

The customer requested that in the first position, port numbers 4 and 5 would be blocked off and inlet port 1 would direct to outlet port 3, while inlet port 2 would direct to outlet port 6. In position 2, inlet port 1 would direct to outlet ports 3 and 4, and inlet port 2 would direct out to outlet ports 5 and 6. No ports were blocked in position 2. In position 3, inlet port 1 would direct to outlet port 4, and inlet port 2 would direct flow to outlet port 5 with ports 3 and 6 blocked off. For position 4, inlet port 1 directs flow to outlet port 6, inlet port 2 directs flow to outlet port 3 and ports 4 and 5 are blocked off. In position 5, inlet port 1 directs flow to outlet ports 5 and 6, inlet port 2 directs flow to outlet ports 3 and 4 with ports no ports blocked off. Finally, in position 6, inlet port 1 directs flow to outlet port 5, inlet port 2 directs flow to outlet port 4 and ports 3 and 6 are blocked off.

The customer left the applicant to solve this problem. The desired flow paths needed to be provided to meet the objectives of the applicant's customer.

### SUMMARY OF THE INVENTION

It is the object of many embodiments of the present invention to provide an improved six port valve having two inputs and four potential outputs capable of changing flow configurations in six separate positions of the valve.

It is the object of many embodiments of the present invention to provide an improved multi-port valve.

It is another object of many embodiments of the present invention to provide an improved six position valve, possibly having two inputs and four outputs.

It is another object of many embodiments of the present invention to provide an improved an ability to provide a specific flow path to connect specific inputs to specific outputs, preferably without mixing of the flow paths at the valve.

It is another object of many embodiments to provide selective positions at a valve to selectively direct specific inputs to specific outputs in a prearranged configuration while selectively securing two of the inputs and not mixing fluid streams internal to valve.

Accordingly, in accordance with many embodiments of the present invention a valve body is provided with a plurality of ports, such as six ports on an exterior cylindrical surface selected from ports 1-6. Some embodiments may position the ports symmetrically about the valve body. By rotating an interior director, insert or stemshell which is preferably machined or otherwise formed to provide communication between specific ports when placed at specific angular relationships of the stemshell relative to the housing while preferably selectively securing at least one, if not opposing outputs. Additionally, specific ports can direct flow from specific inlet ports to specific outlet ports to accomplish multiple such as six different flow paths depending on the angular position or rotational position of the insert or stemshell relative to the housing.

A first channel, such as through or along exterior surfaces of the insert may be utilized to communicate a specific inlet port with a specific outlet port(s), possibly while blocking selected and/or opposing outlet port flow. Meanwhile another inlet port may communicate through a second channel in the insert to direct fluid to at least one other outlet port(s) without inter mixing the fluid streams

Separate flow paths may be maintained based on the angular position of the insert which can have an actuator extending perpendicularly away from the ports port and operated by various electrical, mechanical and/or other actuators as are known in the art.

The applicant's design aligns ports 1-6 in a common plane. Other designs may have ports non coplaner with other ports. Other embodiments may incorporate features of this invention with other port combinations and constructions.

### BRIEF DESCRIPTION OF THE DRAWINGS

These and other attributes of the invention will become more clear upon a thorough study of the following description of the best mode for carrying out the invention, particularly when reviewed in conjunction with the drawings, wherein:

FIG. 1 is a top perspective view of a presently preferred embodiment of a valve of the present invention;

FIG. 2 is a bottom perspective view of the embodiment shown in FIG. 1;

FIG. 3 is a cross sectional view taken along the line A-A of the valve shown in FIGS. 1-2 in a first position;

FIG. 4 is a cross sectional view taken along the line A-A of the valve shown in FIGS. 1-2 in a second position;

FIG. 5 is a cross sectional view taken along the line A-A of the valve shown in FIGS. 1-2 in a third position;

FIG. 6 is a cross sectional view taken along the line A-A of the valve shown in FIGS. 1-2 in a fourth position;

FIG. 7 is a cross sectional view taken along the line A-A of the valve shown in FIGS. 1-2 in a fifth position; and

FIG. 8 is a cross-sectional view taken along the line AA of FIG. 1 with the stemshell in a sixth position.

### DETAILED DESCRIPTION OF THE PREFERRED EMBODIMENT

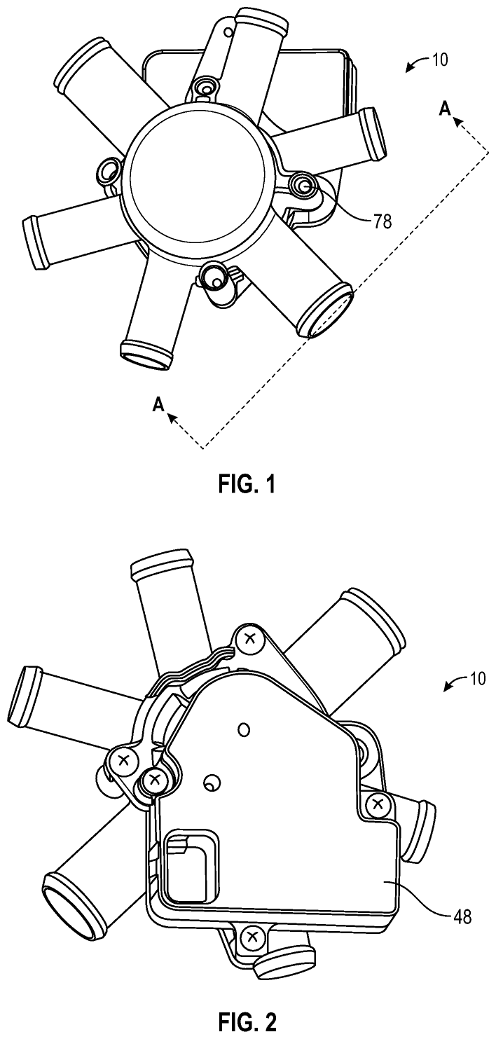

FIG. 1 shows a valve 10 of a presently preferred embodiment. The valve 10 has first, second, third, fourth, fifth and sixth ports 12,14,16,18,20,22 respectively. The first through sixth ports 12-22 for many embodiments are dedicated inlet or outlet ports. Specifically, first port 12 and second port 14 have been designed as inlet ports for the illustrated embodiments, while second, third, fourth, fifth, and sixth ports 14,16,18,20,22 respectively have been designed as outlet ports. Other embodiments may have different inlet/outlet ports and/or ports that may not necessarily be dedicated to only inlet or outlet ports. Various fluids whether liquid and/or gas may flow through various embodiments of valve 10. A stemshell 24 may be utilized to change positions or flow paths directed by the valve 10. Many embodiments may utilize a single stemshell 24.

A different position of the stemshell 24 or insert relative to the housing 26 is calculated to provide different flow paths from the various inputs 12,14 to be directed selectively to respective outputs 16,18,20,22.

The stemshell 24 is preferably substantially cylindrical about its radial exterior surface 28 and may selectively align one of its first and second channels 30,32 with one of two ports such as inlet ports 12,14 on or through the housing 26 illustrated directing fluid selectively through first and second channels 30,32 without intermixing to flow through the other channel 30 or 32 then proceed to one or more of the outlet ports 16,18,20,22 as appropriate. Stemshell 24 is preferably rotatable about axis 34 internal to the housing 26 for at least some embodiments to selectively direct flow in a specific position 1-6 from one of the first and second ports 12,14 to one or more of the selected outlet ports 16,18,20,22. Channels 30,32 may be curved for many embodiments and may be spaced by connecting wedges 36,38 providing stops 40,42 along exterior surface 28 of the stemshell 24. Side portions 44,46 may assist in defining channels 36,38 with wedges 36,38.

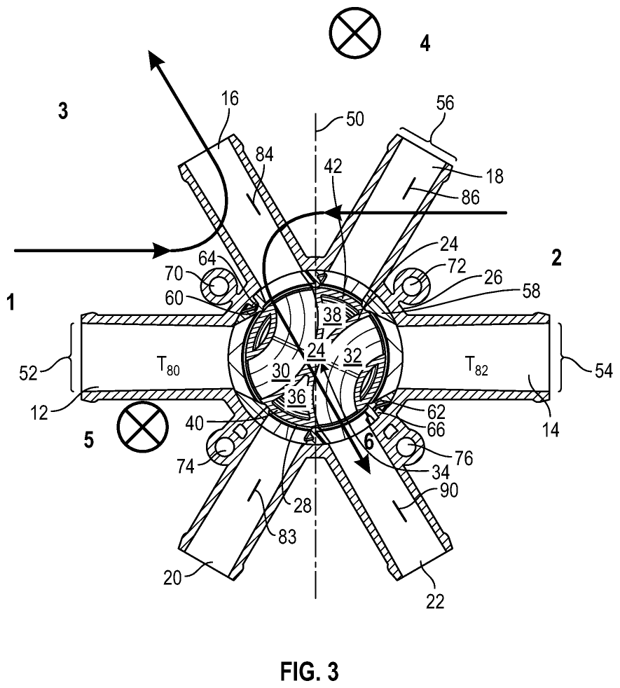

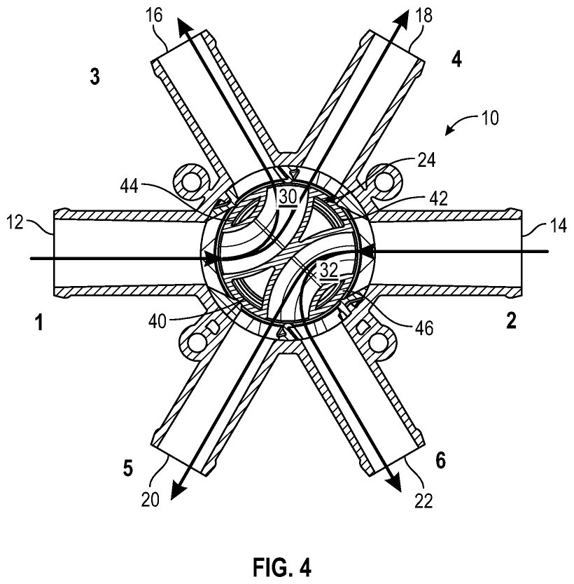

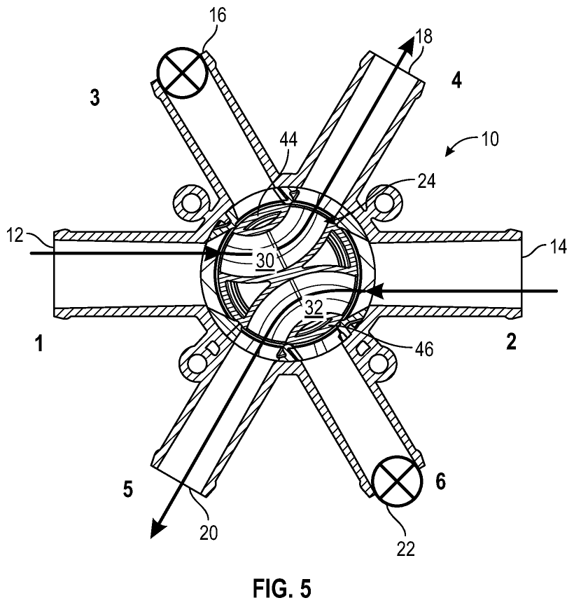

For instance, first position, shown in FIG. 3, has stops 40,42 preventing flow from proceeding out ports four 18 and five 20. Meanwhile flow from port one 12 is directed through channel 30 to port three 16 and flow from port two 14 is directed through channel 32 out port six 22. Stops 40,42 may simultaneously prevent flow from two outlets, four 18 and five 20 in this position for this embodiment. Stops 40,42 are also 180 degrees apart in this construction as well, but could potentially have other relationships in other embodiments.

By turning the stemshell 24 clockwise, or otherwise, from the first position to the second position, flow can continue from the first port 14 to the sixth port 22, but also proceed simultaneously into the fifth port from the first port 14 through the second channel 32. Meanwhile the first port 12 can direct flow through the third port 16 and the fourth port 18 through the first channel 30. The stops 40,42 may not fully block off the fourth port 18 and fifth port 20, but instead are sufficiently moved so that channel 30 can communicate with both third and fourth outlet ports 16,18 and channel 32 can communicate with both fifth and sixth outlet ports 20,22, respectively, without co-mixing of the streams within the valve 10 between the channels 30,32. Side portions 44,46 of stemshell 24 may not completely block any of the outlet ports 16,18,20,22 in either first, second or other position.

A third position of the valve 10 can be achieved with the presently preferred embodiment by rotating the stemshell 24, such as slightly more clockwise, or otherwise, so that the first channel 30 may communicate flow from the first port 12 to the fourth port 18. The second channel 32 may communicate flow from the second port 14 to the fifth port 20. The side portions 44,46 may block off flow to the third port 16 and sixth port 22, possibly in an opposing orientation, such as 180 degrees apart as illustrated or otherwise.

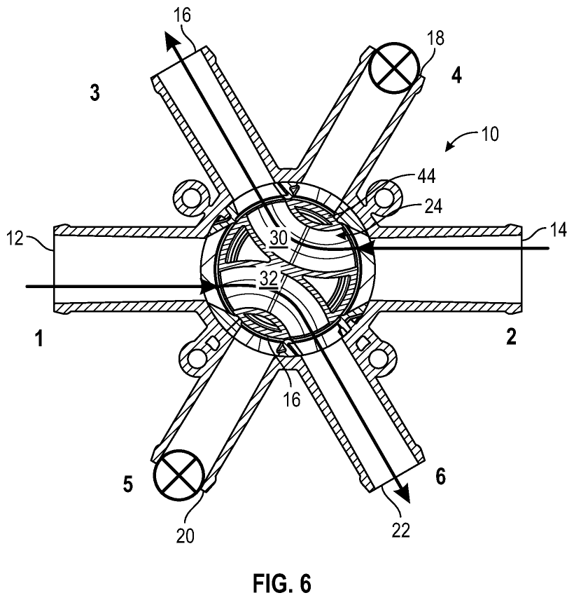

A fourth position of the valve 10 is shown in FIG. 6 for the preferred embodiment. The stemshell 24 may be turned further clockwise, or otherwise, so that the first channel 30 communicates the second port 14 with the third port 16. The side portion 44 may block off flow through fourth port 18. Meanwhile, the second channel 32 may communicate the first port 12 with the sixth port 22 while the side portion 46 may block off flow through the fifth port 20. Side portions 44,46 simultaneously block off two separate ports (fourth and fifth ports 18,22 in this position) in an opposing manner, such as 180 degrees apart or otherwise.

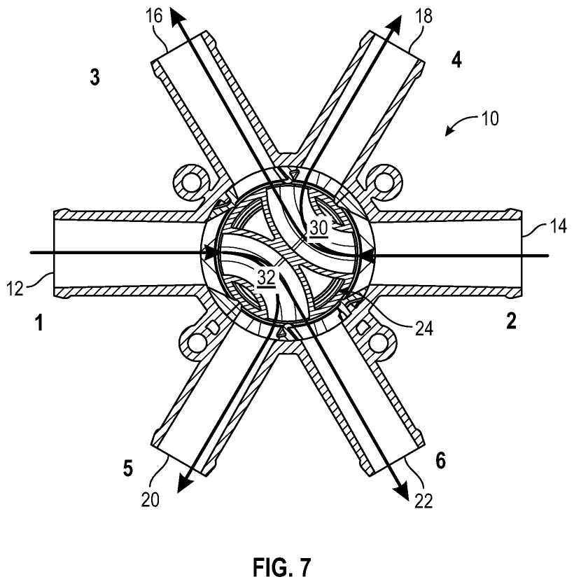

FIG. 7 shows a fifth position of the valve 10. The stemshell is further turned or moved so that the first channel 30 may communicate flow from the second port 14 to both the third and fourth ports 16,18. The second channel 32 may communicate flow from the first port 12 to both the fifth and sixth ports 20,22.

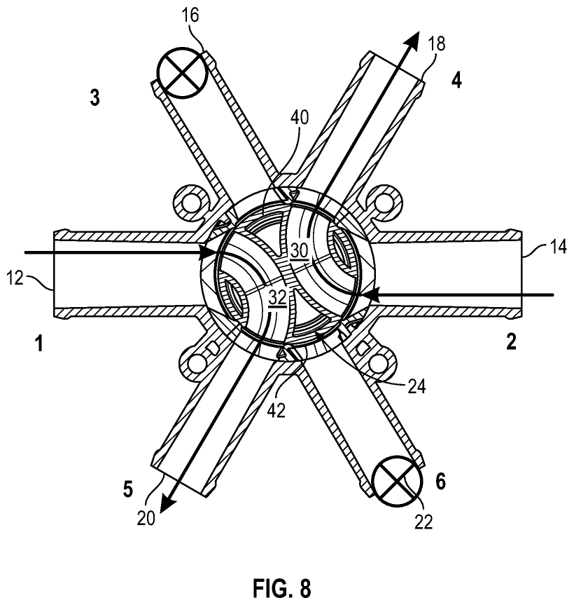

FIG. 8 shows a sixth position of the valve 10 with the stemshell 24 moved again, possibly clockwise, so that the first channel 30 communicates the second port 14 with the fourth channel 18. The third port 16 is blocked by first stop 40. The second channel 32 communicates the first port 12 with the fifth port 20. Second stop 42 prevents flow passing into sixth port 22 from the valve 10.

Manufacturing a valve 10 can be done using various methods known in the art of various materials. The applicant has a molded body providing a valve housing 26 which may be formed in halves with one half having a passage for an actuator to extend through the housing to be controlled by an operator 48, such as the electro-mechanical operator sold under the Ranco™ brand illustrated or other operator. Valve body 26 may be symmetrical about centerline 50 (such as between the first and second ports 12,14 for at least some embodiments. First and second ports 12,14 may have the same or similar bore diameters 52,54, while the third, fourth, fifth and/or sixth bores 16-22 may have similar or different bore diameters 56, particularly where they interface with the stemshell 24. Third, fourth, fifth and sixth bore diameters 56 may be smaller than diameters 52,54 of first and second ports 12,14.

An insert 58 may fit within valve body 26 and provide interior cooperating surface portions to cooperate with exterior surface portions of the stemshell 24 such as along stops 40,42 and/or side portions 44,46 to achieve the desired flow from specific input 12 or 14 to desired output(s), 16-22, respectively. Insert 58 may have grooves 60,62, which cooperate with extensions 64,66 directed radially relative to the valve body 26 to prevent the insert 58 from rotating relative to the valve body 26. Ramps 68 may assist in providing a desired flow from a specific input 12 or 14 into a specific channel 30,32. Any or all of aligning bores 70,72,74,76 may be provided along valve body 26 to assist in receiving connectors 78 to secure valve body portions together to provide valve 10 such as is shown in FIG. 1 or others.

While the inlet ports 12,14 have axes 80,82 aligned with the rotational axis 34 of the stemshell 24 for the illustrated embodiment, the axes 84,86,88,90 of the third, fourth, fifth and sixth ports 16-22, respectively are not collinear with the rotational axis 34 of the stemshell 24. Other embodiments may provide axes 84-90 collinear with the rotation axis 34 of the stemshell 24.

Ports 12-22 may have male ends as illustrated to cooperate with various conduits, connectors etc., or female ends as desired for particular applications.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

What is claimed is:

1. A multi-port valve, comprising:
a housing defining an internal cavity and comprising a plurality of ports with at least a first and a second inlet port and at least first, second and third outlet ports, wherein each of the plurality of ports is in communication with the internal cavity; and a stemshell rotatably disposed within the internal cavity to selectively provide fluid communication between the first inlet port and a first outlet port in a first position to provide fluid communication between the second inlet port and the third outlet port, and a second position with the first inlet port providing fluid communication to both the first and second outlet ports while the second inlet port continues to provide fluid communication to the third outlet port; and fluid flow paths from the first and second inlet ports, respectively, are fluidly separated through the valve and stemshell.

2. The multi-port valve of claim 1 wherein the inlet and outlet ports disposed in a common plane.

3. The multi-port valve of claim 1 where when in the first position, the second outlet port receives no fluid from the first and second inlet ports.

4. The multi-port valve of claim 1 further comprising a fourth outlet port, and a third position, wherein when in the third position, first inlet ports is in fluid communication with the second outlet, and the second inlet port is in fluid communication with the fourth outlet port.

5. The multi-port valve of claim 4, wherein when in the second position, the second inlet port is in fluid communication with both the third outlet port and the fourth outlet port.

6. The multi-port valve of claim 4, wherein when in the third position, the first and third outlet ports receive no fluid from the first and second inlet ports.

7. The multi-port valve of claim 4 wherein when in the first position, the fourth outlet port receives no fluid from the first and second inlet ports.

8. The multi-port valve of claim 4 wherein when in the fourth position, the first inlet port is in fluid communication with the third outlet port, and the second inlet port is in communication with the first outlet port.

9. The multi-port valve of claim 8, wherein when in the second position, the second outlet port is in fluid communication with both the third and fourth outlet ports.

10. The multi-port valve of claim 8, wherein when in the fourth position no flow fourth outlet, the second outlet port receives no fluid from the first and second inlet ports.

11. The multi-port valve of claim 8, further comprising a fourth outlet, and a sixth position, wherein when in the sixth position, the second inlet port is in communication with the second outlet port and the first inlet port is in fluid communication with the fourth outlet port.

12. The multi-port valve of claim 11, wherein when in second position, the second outlet port is in fluid communication with both the third and fourth outlet ports.

13. The multi-port valve of claim 11 wherein when in the sixth position the first outlet port and the third outlet port receive no flow from the first and second inlet ports.

14. The multi-port valve of claim 11 further comprising a fifth position, second inlet to first and second outlet, first inlet to third and fourth outlet port.

15. The multi-port valve of claim 11 wherein when in the second position, the second inlet port is in fluid communication with both the third and fourth outlet ports.

16. The multi-port valve of claim 1, further comprising a first additional position, wherein when in the first additional position, the first inlet port is in fluid communication with the third outlet port and the second inlet port is in fluid communication with the first outlet port.

17. The multi-port valve of claim 16 wherein when in the second position, the second inlet port is in fluid communication with both the third and fourth outlet ports.

18. The multi-port valve of claim 16, further comprising a second additional position, wherein when in the second additional position, the first inlet port is in fluid communication with the third and fourth outlet ports and the second inlet port is in fluid communication with the first and second outlet ports.

19. The multi-port valve of claim 18 wherein when in the second position, the second inlet port is in fluid communication with both the third and fourth outlet ports.

20. The multi-port valve of claim 1 wherein the inlet ports are larger than outlet ports.
